(19) United States
(12) Patent Application Publication
(10) Pub. No.: US 2025/0342693 A1
(43) Pub. Date: Nov. 6, 2025

(54) MULTI-CAMERA VIDEO ANALYSIS USING LARGE LANGUAGE MODELS

(71) Applicant: NEC Laboratories America, Inc., Princeton, NJ (US)

(72) Inventors: Biplob Debnath, Princeton, NJ (US); Srimat Chakradhar, Manalapan, NJ (US); Md Adnan Arefeen, Kansas City, MO (US)

(21) Appl. No.: 19/188,422

(22) Filed: Apr. 24, 2025

Related U.S. Application Data
(60) Provisional application No. 63/640,946, filed on May 1, 2024.

(51) Int. Cl. G06V 20/40; G06V 10/82; G06V 20/56; G06V 20/62

(52) U.S. Cl. CPC G06V 20/41; G06V 10/82; G06V 20/56; G06V 20/62

(57) ABSTRACT

Systems and methods for multi-camera video analysis using large language models. Non-overlapping frames can be identified from multiple video feeds from a base camera and secondary cameras. Similar information from the multiple video feeds can be filtered to remove redundancies from the non-overlapping frames from the non-overlapping frames and obtain filtered frames. Textual data that describes semantic information of entities can be extracted from the filtered frames using a vision-language model (VLM). Undetected objects can be identified from the filtered frames by analyzing the textual data and the entities within different perspectives of the filtered frames. Combined textual captions that combines the textual data and descriptions of the undetected objects into embedded vectors can be generated for the multiple video feeds. Corrective action can be performed for a monitored entity based on the combined textual captions from the embedded vectors.

### RELATED APPLICATION INFORMATION

This application claims priority to U.S. Provisional App. No. 63/640,946, filed on May 1, 2024, incorporated herein by reference in its entirety.

### BACKGROUND

### Technical Field

The present invention relates to video processing using artificial intelligence and more particularly to multi-camera video analysis using large language models.

### Description of the Related Art

Traffic cameras have become ubiquitous in urban environments, with many cities installing hundreds to thousands of them which can continuously capture video footage of traffic scenes. The collected videos can be analyzed to extract insights, conduct investigations, prevent potential disasters, and address various inquiries related to traffic management. The sheer volume of archived traffic data is immense as the volume of traffic data can double or even triple based on the number of video feeds employed. Analyzing the vast amount of data from the video feeds is difficult as this process demands a comprehensive understanding of the information embedded within the videos.

### SUMMARY

According to an aspect of the present invention, a computer-implemented method for multi-camera video analysis is provided, including, identifying non-overlapping frames from multiple video feeds, extracting textual data that describes semantic information of entities from the filtered frames using a vision-language model (VLM), identifying undetected objects from the filtered frames by analyzing the textual data and the entities within different perspectives of the filtered frames, generating combined textual captions for the multiple video feeds that combines the textual data and descriptions of the undetected objects into embedded vectors, and performing corrective action to a monitored entity based on the combined textual captions from the embedded vectors.

According to another aspect of the present invention, a system is provided for multi-camera video analysis, including, a memory device, one or more processor devices operatively coupled with the memory device to perform operations having, identifying non-overlapping frames from multiple video feeds from multiple cameras, extracting textual data from the non-overlapping frames using a vision-language model (VLM), identifying undetected objects from the filtered frames by analyzing the textual data and the entities within different perspectives of the filtered frames, generating combined textual captions for the multiple video feeds that combines the textual data and descriptions of the undetected objects into embedded vectors, and performing corrective action to a monitored entity based on the combined textual captions from the embedded vectors.

According to yet another aspect of the present invention, a non-transitory computer program product including a computer-readable storage medium including a program code for multi-camera video analysis is provided, wherein the program code when executed on a computer causes the computer to perform operations having, identifying non-overlapping frames from multiple video feeds from multiple cameras, extracting textual data from the non-overlapping frames using a vision-language model (VLM), identifying undetected objects from the filtered frames by analyzing the textual data and the entities within different perspectives of the filtered frames, generating combined textual captions for the multiple video feeds that combines the textual data and descriptions of the undetected objects into embedded vectors, and performing corrective action to a monitored entity based on the combined textual captions from the embedded vectors.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a high-level overview of a computer-implemented method for multi-camera video analysis using large language models, in accordance with an embodiment of the present invention;

FIG. 2 is a block diagram showing non-overlapping frames, in accordance with an embodiment of the present invention;

FIG. 3 is a block diagram showing a practical application utilizing an artificial intelligence assistance to generate responses based on a query, in accordance with an embodiment of the present invention;

FIG. 4 is a block diagram showing a system performing downstream tasks of multi-camera video analysis using large language models, in accordance with an embodiment of the present invention;

FIG. 5 is a block diagram showing hardware and software components utilized in a computer system that implements multi-camera video analysis using large language models, in accordance with an embodiment of the present invention;

FIG. 6 is a block diagram showing a computing device implementing multi-camera video analysis using large language models, in accordance with an embodiment of the present invention; and

FIG. 7 is a block diagram showing a structure of deep neural networks for multi-camera video analysis using large language models, in accordance with an embodiment of the present invention.

### DETAILED DESCRIPTION OF PREFERRED EMBODIMENTS

In accordance with embodiments of the present invention, systems and methods are provided for multi-camera video analysis using large language models.

In an embodiment, non-overlapping frames can be identified from multiple video feeds from a base camera and secondary cameras. Similar information from the multiple video feeds can be filtered to remove redundancies from the non-overlapping frames and obtain filtered frames. Textual data that describes semantic information of entities can be extracted from the filtered frames using a vision-language model (VLM). Undetected objects can be identified from the filtered frames by analyzing the textual data and the entities within different perspectives of the filtered frames. Combined textual captions that combines the textual data and descriptions of the undetected objects into embedded vectors can be generated for the multiple video feeds. Corrective action can be performed for a monitored entity based on the combined textual captions from the embedded vectors.

Traffic cameras have become ubiquitous in urban environments, with many cities installing hundreds to thousands of them. These cameras continuously capture video footage of traffic scenarios. The collected videos are then systematically stored for post-analysis. This extensive archive of video data offers city planners and transportation authorities a valuable resource for extracting insights, conducting investigations, preventing potential disasters, and addressing various inquiries related to traffic management. The sheer volume of archived traffic data is immense. For instance, a city with approximately one thousand of these cameras may accumulate as much as two hundred thirty terabytes of video data each month. In a multi-camera setup that captures the same scene from different angles, the volume of traffic data can double or even triple than single camera video feeds. Analyzing such vast amounts of video feeds from traffic cameras is essential for tasks such as traffic monitoring, congestion management, and incident detection. However, this process demands a comprehensive understanding of the information embedded within the videos, highlighting the necessity for advanced analytical tools and methodologies.

In the domain of traffic video analysis, processing user queries through natural language processing enables direct interaction with video content. Large Language Models (LLMs), such as ChatGPT™, have excelled in text-based interactions but face limitations when addressing data not encountered during training. The Retrieval-Augmented Generation (RAG) approach has been widely adopted to augment LLMs with the ability to integrate unseen data. However, traditional RAG systems are designed to handle textual data, posing challenges when dealing with non-textual formats like videos or images common in traffic monitoring. Addressing this gap requires enhancing RAG systems with capabilities to convert these media into text-compatible formats. This adaptation is essential for enabling LLMs to effectively process and respond to queries involving multi-camera traffic video feeds. Usually, Vison-Language Models (VLMs) are used to convert videos or images into text, for proceeding through the RAG framework using LLMs. However, this conversion process is slow, so users have to wait for long time before starting any analysis. This challenge is exacerbated by the fact that multiple cameras are often strategically installed at a traffic intersection to ensure comprehensive coverage.

The multi-camera setup at a traffic intersection is designed with redundancy in mind. Each camera complements the others by capturing events from different angles and perspectives. In situations where one camera may fail to capture a particular event due to obstructions or limitations in its field of view, neighboring cameras are strategically positioned to fill in these gaps. This coordinated arrangement minimizes the risk of incidents going unnoticed, as there is a high probability that any event overlooked by one camera will be captured by another.

However, processing videos captured by the traffic cameras use considerable amount of resources. If converting twenty-four-hour traffic videos using VLMs from one camera takes one day, and an intersection is monitored using four cameras, then it would take more than four days just to extract text from the video footages using VLMs before beginning analysis through LLMs. This presents a significant challenge for various applications, including impeding law enforcement agencies' ability to conduct timely analyses of criminal incidents captured in the video.

The present embodiments can expedite the multi-camera video-to-text conversion process of by adjusting the maximum token limit parameter of VLMs with sophisticated prompt engineering and leveraging the distinctive features of multi-camera setups deployed at traffic intersections.

The present embodiments present a novel algorithm for rapidly generating textual descriptions of video clips using VLM models for the multi-camera setup. The present embodiments optimize the video-to-text conversion process for multi-camera setups at traffic intersections by adjusting the output token limit in Vision Language Models (VLMs). VLMs include configuration settings such as a maximum token limit parameter to control the volume of generated information and manage inference speed. The present embodiments propose strategically reducing the configuration settings of the VLMs (e.g., token limit) across multiple cameras to decrease ingestion time. This reduction targets the elimination of redundant information contained in overlapping video frames from different cameras at the same time. Through sophisticated prompt engineering and by leveraging the distinct perspectives offered by multi-camera configurations, the present embodiments can efficiently streamline the conversion process while maintaining essential information integrity.

To speed up the video-to-text conversion process, the present embodiments propose an innovative algorithm designed to quickly produce textual descriptions of video clips using Vision-Language Models (VLMs) for monitoring traffic intersections equipped with multiple cameras. The present embodiments can capitalize on the overlapping coverage areas of the cameras at these intersections. The present embodiments can apply a VLM to the video clip from one camera, prompting it to generate detailed descriptions while employing a higher token limit (e.g., two hundred fifty-six). The present embodiments can utilize the resulting output as a prompt for the next camera, instructing the VLM to include additional details not initially covered, while enforcing a lower token limit (e.g., one hundred twenty-eight). This iterative process continues for subsequent cameras, with each iteration incorporating further details from previous cameras and reducing the token limit (e.g., sixty-four for the third camera and thirty-two for the fourth camera). Furthermore, it can bypass subsequent VLM calls when it detects a high degree of similarity among the video feeds from different cameras.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

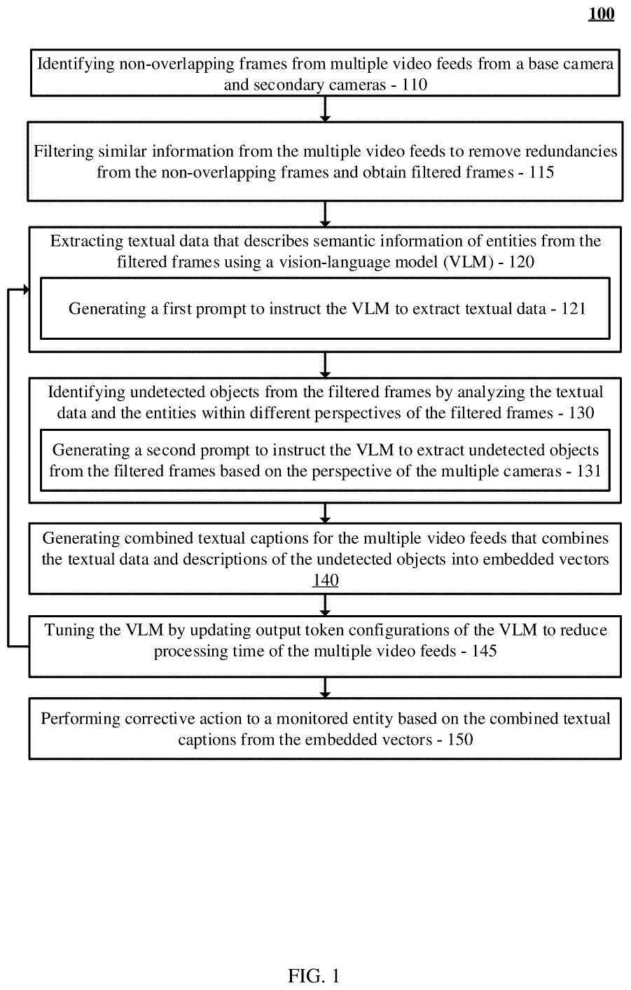

Referring now in detail to the figures in which like numerals represent the same or similar elements and initially to FIG. 1, a high-level overview of a computer-implemented method for multi-camera video analysis using large language models is illustratively depicted in a block diagram in accordance with an embodiment of the present invention.

In an embodiment, non-overlapping frames can be identified from multiple video feeds from a base camera and secondary cameras. Similar information from the multiple video feeds can be filtered to remove redundancies from the non-overlapping frames and obtain filtered frames. Textual data that describes semantic information of entities can be extracted from the filtered frames using a vision-language model (VLM). Undetected objects can be identified from the filtered frames by analyzing the textual data and the entities within different perspectives of the filtered frames. Combined textual captions that combines the textual data and descriptions of the undetected objects into embedded vectors can be generated for the multiple video feeds. Corrective action can be performed for a monitored entity based on the combined textual captions from the embedded vectors.

In block 110, non-overlapping frames can be identified from multiple video feeds.

The present embodiments can select a video feed from multiple video feeds from the multiple cameras including a base camera and secondary cameras. The base camera can be determined based on a number of previously detected objects. For example, the base camera can be the camera having the largest number of previously detected objects. The secondary cameras can be the remaining cameras from the multiple cameras.

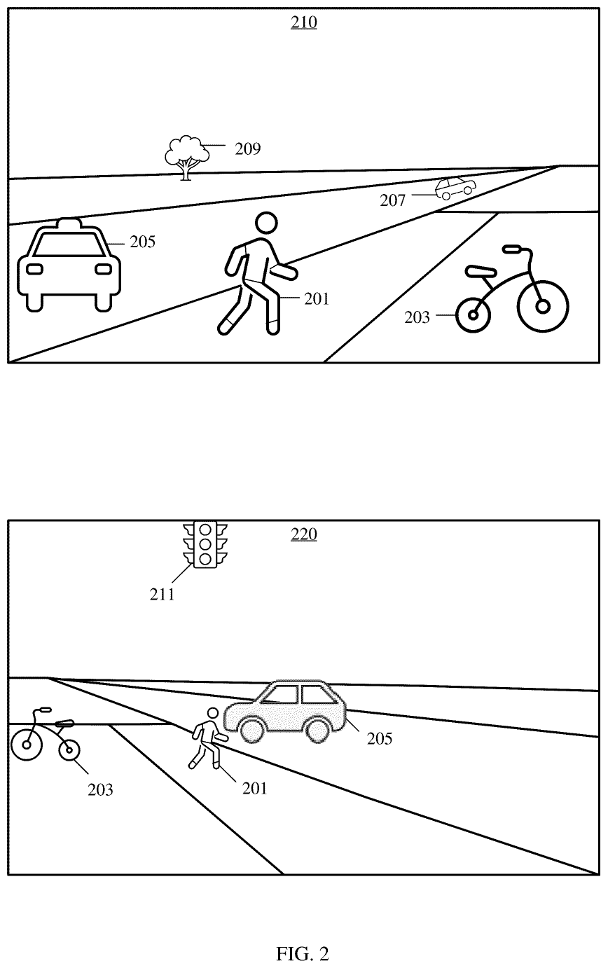

To identify the non-overlapping frames, a scene detector can be employed. The non-overlapping frames are frames that contain distinct perspectives of a scene having distinct entities. An example of non-overlapping frames is shown in FIG. 2.

Referring now to FIG. 2, a block diagram showing non-overlapping frames, in accordance with an embodiment of the present invention.

Multiple cameras covering the same view from different positions can provide distinct perspectives. While there is some overlap in the scenes captured, each camera may also record objects that are only visible from its specific vantage point. Consequently, in a multi-camera setup at a traffic intersection, extracting information independently from each camera can lead to the accumulation of redundant data, which in turn impacts the efficiency of video ingestion.

FIG. 2 shows two frames 210 and 220 taken at the same timestamp showing the same scene but with different perspectives. Both frame 210 and 220 contain a man 201, bicycle 203, and a taxi 205. However, only frame 210 contains tree 209 and car 207 while only frame 220 contains traffic light 211. The scene detector would detect frames 210 and 220 as non-overlapping frames.

The traffic light 211 can show that the light is green for cars and red for pedestrians. The man 201 can be detected wearing casual clothes without any head covering. The taxi 205 can be detected as a green sport utility vehicle (SUV) that is turning left.

Referring back now to FIG. 1. The scene detector can employ a scene detecting algorithm to identify the non-overlapping frames that combines image processing methods such as feature extraction, overlap detection, clustering, etc. The scene detector can employ a vision language model (VLM) to perform the processing methods. In another embodiment, the scene detector can employ a neural network, such as convolutional neural networks, trained to perform the processing methods.

To perform feature extraction, an optical flow can be computed between frames such as Lucas-Kanade Method, Horn-Schunck Method, Gunnar-Farneback Method, etc. To perform overlap detection, region of interests (ROI) can be detected for each frame and the intersection between the ROI can be computed. Additionally, overlap can be detected by measuring the structural similarity index (SSIM) and random sample consensus (RANSAC) can be performed. Clustering can be performed to cluster the frames into non-overlapping and overlapping clusters.

In block 115, similar information can be filtered from the multiple video feeds to remove redundancies from the non-overlapping frames and obtain filtered frames.

In most multi-camera setups, there is an overlapping region where the same objects are captured by all cameras. Additionally, during periods of no traffic (e.g., when roads are empty), all cameras capture no objects and thus share similar information. Taking this into account, the present embodiments can implement a similarity detector to identify similarities in multi-camera scenes. The present embodiments can use object-level similarity as a metric for similarity detection, employing the Intersection over Union (IoU) score for quantification. When the IoU score exceeds a specified threshold, the Vision-Language Model (VLM) is not invoked for that clip to avoid generating redundant textual information already obtained from the base camera.

Conversely, if the similarity falls below the threshold, the VLM model is engaged to gather more detailed information. The non-overlapping frames having the calculated similarity falling below the threshold can be saved as filtered frames.

This approach enables a more refined analysis of visual data across different camera feeds. Using object similarity provides advantages over determining scene similarity as frame-level similarity can have difficulty distinguishing object-level similarity. For example, for detecting similarity in multiple camera feeds as shown in FIG. 2, frame-level similarity would still provide high similarity scores as the cameras are viewing the same scene despite having multiple object discrepancies. Setting an appropriate threshold for frame similarity across various cameras can be difficult due to fluctuations in traffic scenes, time and camera position.

In block 120, textual data that describes semantic information of entities can be extracted from the filtered frames using a vision-language model (VLM).

A vision-language model (VLM) can be utilized to extract textual data from the filtered frames. The VLM can be pretrained to identify and extract textual data from images. With a Vision-Language Model (VLM), it runs a prompt to extract the details. For example, the prompt can include “Compose a descriptive narrative.” After completing the ingestion from the base camera, the present embodiments obtain the base text for each clip from the base camera.

In block 121, a prompt can be generated to instruct the VLM to extract the textual data.

The VLM can be instructed with a prompt. The prompt can be generated with a prompt generator. In another embodiment, the prompt generator can learn prompt engineering to generate the appropriate instruction prompts to instruct the VLM to extract the textual data from the frames.

In block 130, undetected objects from the filtered frames can be identified by analyzing the textual data and the entities within different perspectives of the filtered frames.

The present embodiments can intuitively employ a second prompt to delve deeper and extract additional details from the clips of the next camera with the same time frame as the base camera so that distinct information from all cameras can be covered. The second prompt can include “The image describes [result of prompt 1]. Describe the undetected objects.” Since multiple cameras can cover the same scene from various angles, this approach leverages the distinct positioning of each camera to enrich the overall context and understanding of the scenario.

In block 131, a second prompt can be generated to instruct the VLM to extract undetected objects from the filtered frames based on the perspective of the multiple cameras.

The selection of the second prompt is specifically designed to compel the Vision Language Model (VLM) to extract information solely about entities that were not detected initially. This approach significantly reduces redundancy from subsequent camera feeds. However, while using the first prompt, the base camera text generally captures most of the information. Consequently, when the second prompt is applied to subsequent cameras, it often redundantly identifies objects that have already been detected. The entities that have been detected can be filtered as such entities can have similar or identical textual data. Undetected objects can then be analyzed as entities that have not been identified or have a number less than a threshold number (e.g., two) of textual data describing them.

For example, in FIG. 2, the entities man 201 and bicycle 203 have more textual data than tree 209 and traffic light 211. If the total number of textual data for the tree 209 and traffic light 211 are less than a threshold number (e.g., two), then the undetected objects can include the tree 209 and the traffic light 211.

In block 140, combined textual captions can be generated for the multiple video feeds that combines the textual data and descriptions of the unrecognizable objects into embedded vectors.

The textual data and descriptions from the cameras are combined to generate a combined textual caption that describes the events captured at the traffic intersection clip by clip basis. Collating text information from all clips generates a lengthy document for the video file, which is then segmented into chunks. Each chunk is embedded into a vector by an embedding model and subsequently stored in a vector database. The correspondence between the chunk and the clips is also stored.

In block 145, the VLM can be tuned by updating output token configurations of the VLM to reduce processing time of the multiple video feeds.

The latency involved in converting video feeds to text is influenced by the number of output tokens produced by the Vision-Language Models (VLMs). To reduce ingestion time, the present embodiments can limit the number of tokens generated during this conversion process. For multi camera setup, while calling VLM n-times for n cameras, the present embodiments can set configuration settings of the VLM, such as the maximum token limit high for converting the base camera feed to text using the first prompt. Subsequently, the present embodiments can use a tailored second prompt to generate additional information for other camera feeds, specifically targeting any details that may have been missed by the base feed and lowering the maximum token limit. This strategy significantly decreases the processing time for setups involving multiple cameras. This limit in tokens helps reduce the token generation along with repetitive information.

The appropriate token limit can be learned by a configuration adjuster. In an embodiment, the configuration adjuster can utilize a neural network which considers the correlation between the latency and the output tokens produced by the VLMs. Other configuration settings (e.g., temperature, frequency penalty, etc.) can be utilized and learned to reduce processing time of the multi-camera feeds.

The configurations of the VLM can be adjusted before instances where the VLM are utilized. For example, before extracting data from the filtered frames, the token configuration of the VLM can be updated. The configurations of the VLM can be adjusted iteratively until a threshold ingestion time is reduced (e.g., one millisecond, etc.).

In block 150, corrective action can be performed to a monitored entity based on the combined textual captions from the embedded vectors.

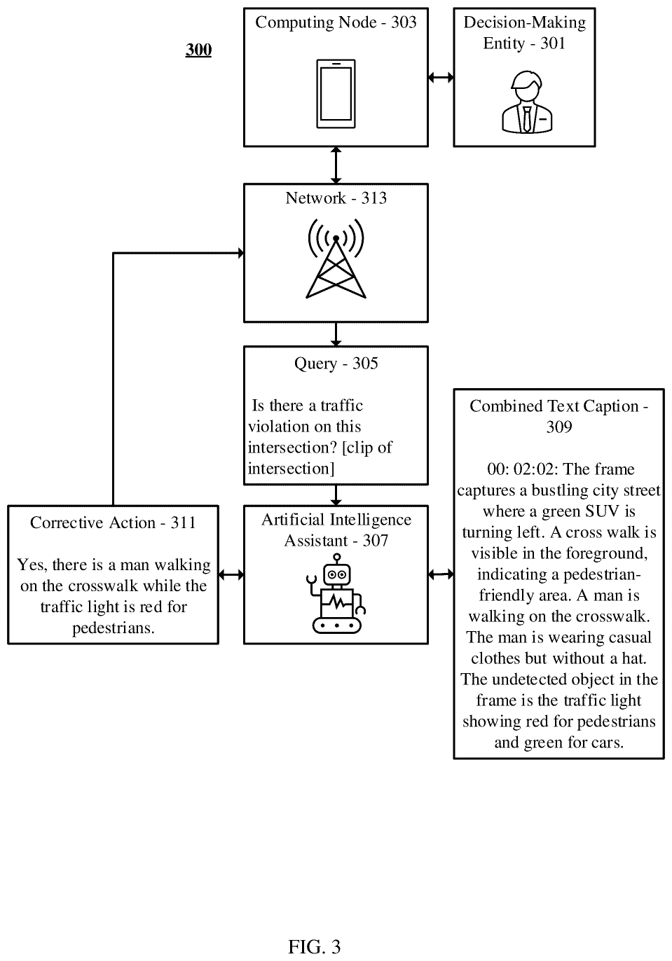

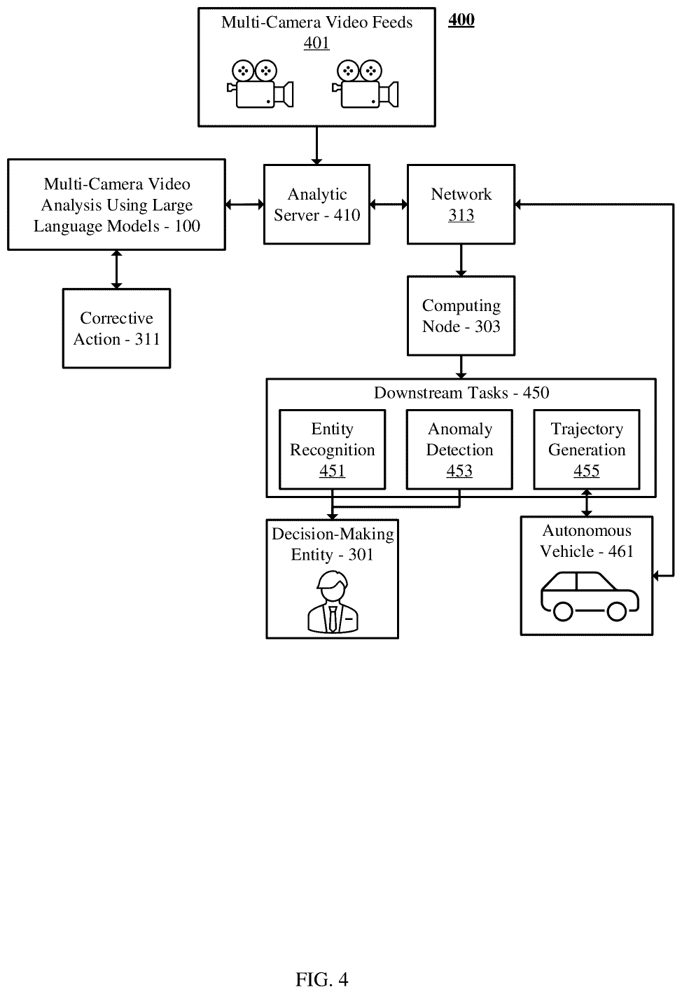

The combined textual captions can be further processed to perform a corrective action to a monitored entity. This is shown in more detail in FIGS. 3-4.

Referring now to FIG. 3, a block diagram showing a practical application utilizing an artificial intelligence assistance to generate responses based on a query, in accordance with an embodiment of the present invention.

In system 300, a decision-making entity 301 can communicate a query 305 to an artificial intelligence assistant 307 through a computing node 303. The query 305 can be related to particular domain such as determining traffic violations, anomaly detection, network security, etc. The query 305 can include attachments such as a video clip, audio file, code snippet, log file, etc. The artificial intelligence assistant 307 can be used to determine traffic violations at a particular intersection.

To determine the traffic violations, the artificial intelligence assistant 307 can understand a combined textual caption 309 that is generated based on video feeds obtained on multiple cameras installed at the particular intersection. In an embodiment, the artificial intelligence assistant 307 can utilize a large language model that can perform semantic search and understanding on the video feeds and combined textual caption 309 to determine whether there is a traffic violation in the video feed.

The artificial intelligence assistant 307 can generate a corrective action 311 in response to the query 305 regarding the traffic violation. The corrective action 311 can be transmitted to the computing node 303 through a network. The present embodiments can perform other downstream tasks. This is shown in more detail in FIG. 4.

Referring now to FIG. 4, a block diagram showing a system performing downstream tasks of multi-camera video analysis using large language models, in accordance with an embodiment of the present invention.

In system 400, multi-camera video feeds 401 can be analyzed by an analytic server 410. The analytic server 410 can implement multi-camera video analysis using large language models 100 and generate corrective action 311. The corrective action 311 can be sent to computing nodes 303, including an autonomous vehicle 461, through a network 313. The analytic server 410 can perform downstream tasks 450. The downstream tasks can include entity recognition 451, anomaly detection 453, and trajectory generation 455.

In entity recognition 451, entities (e.g., people, vehicles, parts of a monitored system, etc.) can be recognized by the system 400. After recognizing the entities, the system 400 can generate a corrective action (e.g., avoiding, redirecting the monitored system, detecting a traffic violation, etc.) depending on the context and the downstream task (e.g., entity monitoring, traffic violation detection, etc.)

In anomaly detection 453, the anomalies (e.g., cancer cells in humans, malfunctioning part in an autonomous vehicle 461, malicious packets in a network data stream, etc.) can be detected by the system 400. After detecting the anomalies, the system 400 can generate a corrective action 311 (e.g., generating a treatment based on the detected cells, cooling or removing the malfunctioning part, removing the malicious packet and blocking the internet protocol address of the sender of the malicious packets, etc.) depending on the context.

In trajectory generation 455, the system can generate a trajectory within a traffic scene simulated from real-world data obtained by sensors (e.g., light detection and ranging [LIDAR], radio detection and ranging [RADAR], cameras, etc.). Based on the trajectory generated, the system 400 can generate a corrective action (e.g., slowing down, changing direction, speeding up, etc.) to meet a threshold comfort and goal (e.g., estimated time, mileage goal, speed, etc.) of a customer.

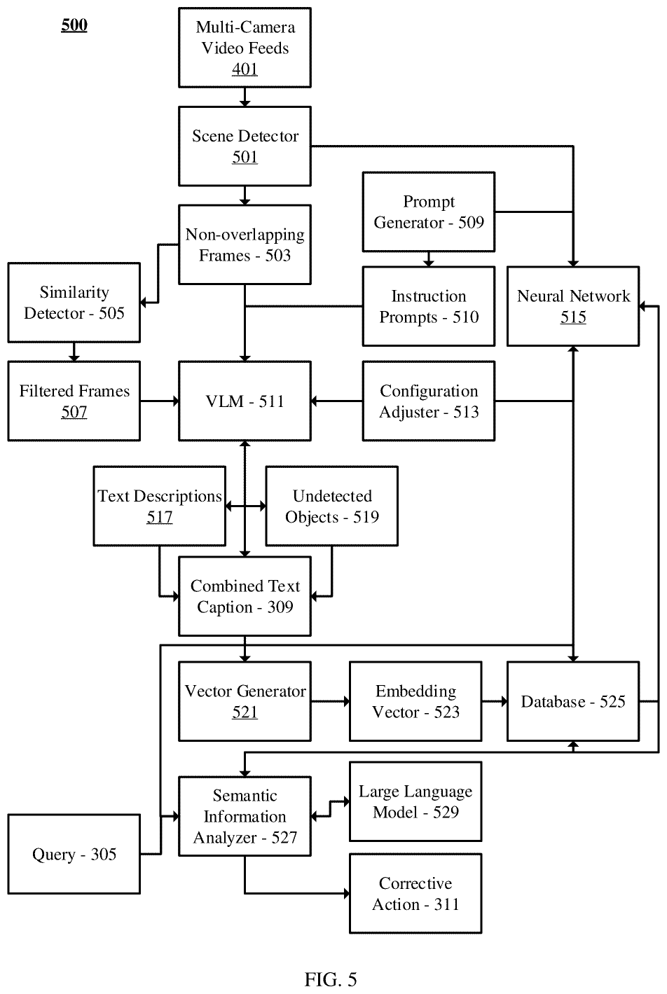

Referring now to FIG. 5, a block diagram showing hardware and software components utilized in a computer system that implements multi-camera video analysis using large language models, in accordance with an embodiment of the present invention.

In system 500, multi-camera video feeds 401 can be processed by a scene detector 501 to identify non-overlapping frames 503 by utilizing a neural network 515. The non-overlapping frames 503 can be processed by a vision language model (VLM) 511 to generate text descriptions 517 of the non-overlapping frames 503 and identify undetected objects 519 from different perspectives of the multi-camera video feeds 401. The VLM 511 can be instructed on how to process the non-overlapping frames 503 with instruction prompts 510. The instruction prompts 510 can be generated by a prompt generator 509. The prompt generator 509 can also utilize the neural network 515. The VLM 511 can process the text descriptions 517 and undetected objects 519 to generate combined textual captions 309.

In an embodiment, the non-overlapping frames 503 can be processed by a similarity detector 505 can obtain filtered frames 507 to remove redundancies from the non-overlapping frames from the non-overlapping frames in the non-overlapping frames 503 and increase accuracy of the text descriptions 517 and undetected objects 519 obtained by the VLM 511. In an embodiment, the configuration settings such as the maximum token limit of the VLM 511 can be adjusted by a configuration adjuster 513. The configuration adjuster 513 can utilize the neural network 515. The accuracy and efficiency of the VLM 511 on how to generate text descriptions 517 and identify undetected object 519 can be increased by adjusting the configuration settings of the VLM 511.

The combined textual captions 309 can be processed by a vector generator 521 to generate embedding vectors 523 that includes text information for the non-overlapping frames 503 which are segmented into chunks. The embedding vectors 523 can be stored in a database 525. The data in the database 525 can be utilized to train neural network 515.

In an embodiment, a query 305 can be processed by a semantic information analyzer 527 with the combined textual caption 309 to generate a corrective action 311. The semantic information analyzer 527 can also utilize the neural network 515. In an embodiment, the semantic information analyzer 527 can utilize a large language model 529.

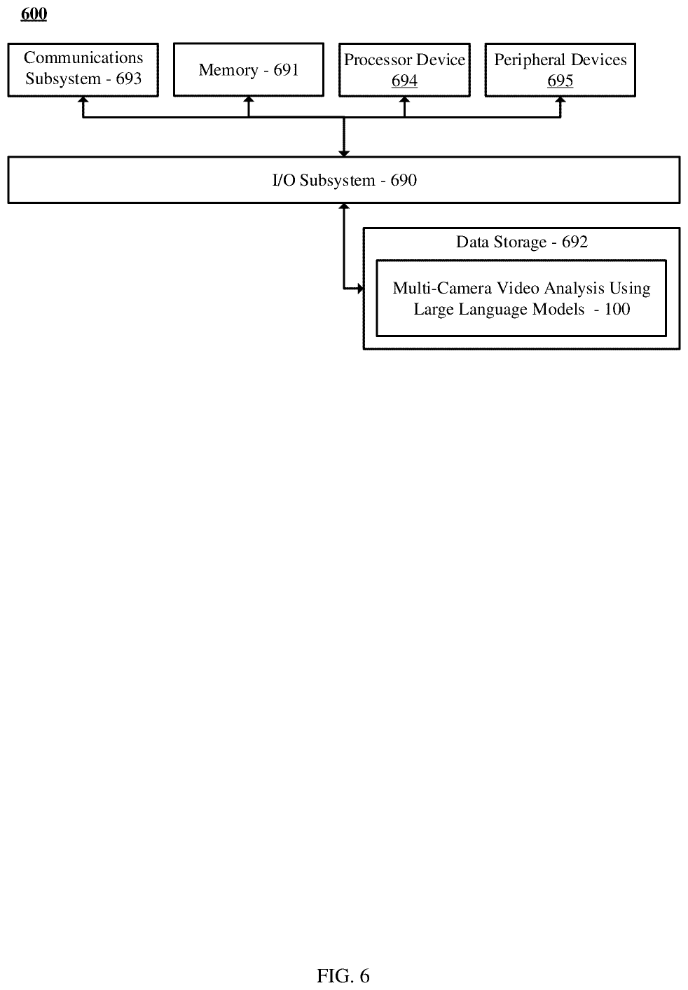

Referring now to FIG. 6, a block diagram showing a computing device implementing multi-camera video analysis using large language models, in accordance with an embodiment of the present invention.

The computing device 600 illustratively includes the processor device 694, an input/output (I/O) subsystem 690, a memory 691, a data storage device 692, and a communication subsystem 693, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 691, or portions thereof, may be incorporated in the processor device 694 in some embodiments.

The processor device 694 may be embodied as any type of processor capable of performing the functions described herein. The processor device 694 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 691 may be embodied as any type of volatile or non-volatile memory or data storage capable of performing the functions described herein. In operation, the memory 691 may store various data and software employed during operation of the computing device 600, such as operating systems, applications, programs, libraries, and drivers. The memory 691 is communicatively coupled to the processor device 694 via the I/O subsystem 690, which may be embodied as circuitry and/or components to facilitate input/output operations with the processor device 694, the memory 691, and other components of the computing device 600. For example, the I/O subsystem 690 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 690 may form a portion of a system-on-a-chip (SOC) and be incorporated, along with the processor device 694, the memory 691, and other components of the computing device 600, on a single integrated circuit chip.

The data storage device 692 may be embodied as any type of device or devices configured for short-term or long-term storage of data such as, for example, memory devices and circuits, memory cards, hard disk drives, solid state drives, or other data storage devices. The data storage device 692 can store program code for multi-camera video analysis using large language models 100. Any or all of these program code blocks may be included in a given computing system.

The communication subsystem 693 of the computing device 600 may be embodied as any network interface controller or other communication circuit, device, or collection thereof, capable of enabling communications between the computing device 600 and other remote devices over a network. The communication subsystem 693 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 695. The peripheral devices 695 may include any number of additional input/output devices, interface devices, and/or other peripheral devices. For example, in some embodiments, the peripheral devices 695 may include a display, touch screen, graphics circuitry, keyboard, mouse, speaker system, microphone, network interface, and/or other input/output devices, interface devices, GPS, camera, and/or other peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 600 are readily contemplated by one of ordinary skill in the art given the teachings of the present invention provided herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

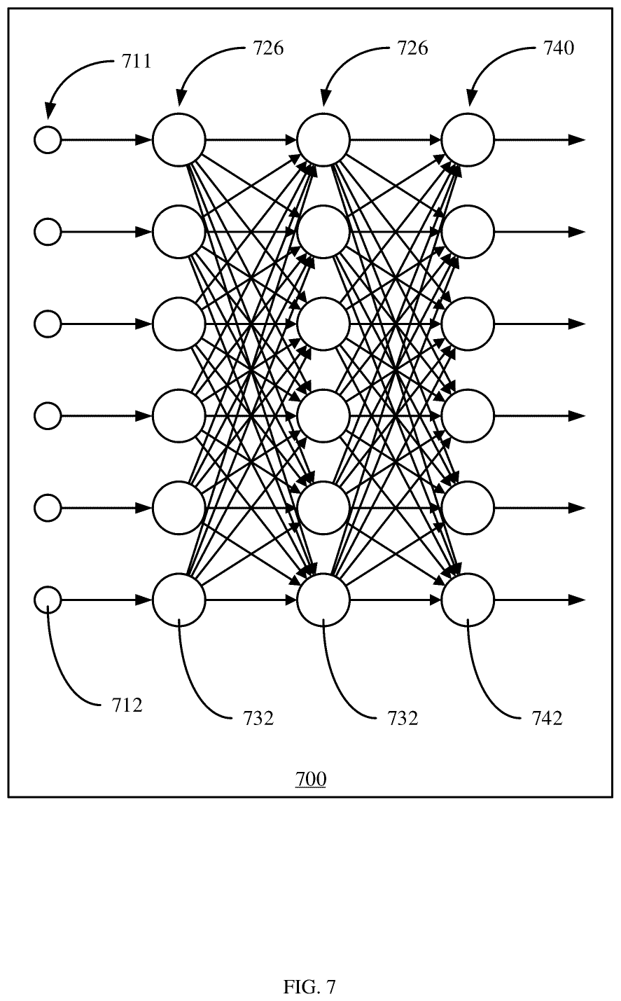

Referring now to FIG. 7, a block diagram showing a structure of deep neural networks for multi-camera video analysis using large language models, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 700, such as a multilayer perceptron, can have an input layer 711 of source neurons 712, one or more computation layer(s) 726 having one or more computation neurons 732, and an output layer 740, where there is a single output neuron 742 for each possible category into which the input example could be classified. An input layer 711 can have a number of source neurons 712 equal to the number of data values 712 in the input data 711. The computation neurons 732 in the computation layer(s) 726 can also be referred to as hidden layers, because they are between the source neurons 712 and output neuron(s) 742 and are not directly observed. Each neuron 732, 742 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 726 of the neural network 515 utilized in the prompt generator 509 can learn corresponding relationships between sub-heuristics (e.g., part of logic), heuristics (e.g., logical rules), and past instruction prompts 510 to generate an instruction prompt 510 as the output of the output layer 742 of the neural network 515. The neural network 515 utilized in the prompt generator 509 can also learn prompt engineering (e.g., zero shot prompting, few-shot prompting, chain-of-thought prompting etc.) to generate the instruction prompt 510.

In another embodiment, the neural network 515 can learn optimal configuration settings for the configuration adjuster 513 based on past data on how the VLM processes the non-overlapping frames 503, filtered frames 507, and the instruction prompts 510.

In another embodiment, the neural network 515 can learn semantic information

from the query 305 and the combined textual caption 309 to generate a corrective action 311.

Training a deep neural network can involve two phases, a forward phase where the weights of each neuron are fixed and the input propagates through the network, and a backwards phase where an error value is propagated backwards through the network and weight values are updated. The computation neurons 732 in the one or more computation (hidden) layer(s) 726 perform a nonlinear transformation on the input data 712 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for multi-camera video analysis, comprising:
identifying non-overlapping frames from multiple video feeds from a base camera and secondary cameras;
filtering similar information from the multiple video feeds to remove redundancies from the non-overlapping frames from the non-overlapping frames and obtain filtered frames;
extracting textual data that describes semantic information of entities from the filtered frames using a vision-language model (VLM);
identifying undetected objects from the filtered frames by analyzing the textual data and the entities within different perspectives of the filtered frames;
generating combined textual captions for the multiple video feeds that combines the textual data and descriptions of the undetected objects into embedded vectors; and
performing corrective action to a monitored entity based on the combined textual captions from the embedded vectors.

2. The computer-implemented method of claim 1, wherein performing the corrective action further comprises generating query responses having semantic information learned from the combined textual captions related to the monitored entity.

3. The computer-implemented method of claim 1, wherein performing the corrective action further comprises controlling an autonomous vehicle based on a trajectory generated by a neural network after processing the combined textual captions and the multiple video feeds.

4. The computer-implemented method of claim 1, wherein identifying the non-overlapping frames further comprises identifying the base camera based on a number of objects previously detected by a camera.

5. The computer-implemented method of claim 1, wherein extracting the textual data further comprises generating a first prompt to instruct the VLM to extract textual data.

6. The computer-implemented method of claim 1, wherein identifying the undetected objects further comprises generating a second prompt to instruct the VLM to extract undetected objects from the non-overlapping frames based on the perspective of the multiple video feeds.

7. The computer-implemented method of claim 1, wherein filtering the similar information further comprises comparing intersection over union scores of results of object-level similarity detection to a threshold.

8. The computer-implemented method of claim 1, further comprising tuning the VLM by updating output token configurations of the VLM to reduce processing time of the multiple video feeds.

9. A system for multi-camera video analysis, comprising:
a memory device;
one or more processor devices operatively coupled with the memory device to perform operations including:
identifying non-overlapping frames from multiple video feeds from a base camera and secondary cameras;
filtering similar information from the multiple video feeds to remove redundancies from the non-overlapping frames from the non-overlapping frames and obtain filtered frames;
extracting textual data that describes semantic information of entities from the filtered frames using a vision-language model (VLM);
identifying undetected objects from the filtered frames by analyzing the textual data and the entities within different perspectives of the filtered frames;
generating combined textual captions for the multiple video feeds that combines the textual data and descriptions of the undetected objects into embedded vectors; and
performing corrective action to a monitored entity based on the combined textual captions from the embedded vectors.

10. The system of claim 9, wherein performing the corrective action further comprises generating query responses having semantic information learned from the combined textual captions related to the monitored entity.

11. The system of claim 9, wherein performing the corrective action further comprises controlling an autonomous vehicle based on a trajectory generated by a neural network after processing the combined textual captions and the multiple video feeds.

12. The system of claim 9, wherein extracting the textual data further comprises generating a first prompt to instruct the VLM to extract textual data.

13. The system of claim 9, wherein identifying the undetected objects further comprises generating a second prompt to instruct the VLM to extract undetected objects from the non-overlapping frames based on the perspective of the multiple video feeds.

14. The system of claim 9, wherein filtering the similar information further comprises comparing intersection over union scores of results of object-level similarity detection to a threshold.

15. The system of claim 9, further comprising tuning the VLM by updating output token configurations of the VLM to reduce processing time of the multiple video feeds.

16. A non-transitory computer program product comprising a computer-readable storage medium including a program code for multi-camera video analysis, wherein the program code when executed on a computer causes the computer to perform operations including:
identifying non-overlapping frames from multiple video feeds from a base camera and secondary cameras;
filtering similar information from the multiple video feeds to remove redundancies from the non-overlapping frames from the non-overlapping frames and obtain filtered frames;
extracting textual data that describes semantic information of entities from the filtered frames using a vision-language model (VLM);
identifying undetected objects from the filtered frames by analyzing the textual data and the entities within different perspectives of the filtered frames;
generating combined textual captions for the multiple video feeds that combines the textual data and descriptions of the undetected objects into embedded vectors; and
performing corrective action to a monitored entity based on the combined textual captions from the embedded vectors.

17. The non-transitory computer program product of claim 16, wherein performing the corrective action further comprises generating query responses having semantic information learned from the combined textual captions related to the monitored entity.

18. The non-transitory computer program product of claim 16, wherein extracting the textual data further comprises generating a first prompt to instruct the VLM to extract textual data.

19. The non-transitory computer program product of claim 16, wherein identifying the undetected objects further comprises generating a second prompt to instruct the VLM to extract undetected objects from the non-overlapping frames based on the perspective of the multiple video feeds.

20. The non-transitory computer program product of claim 16, further comprising tuning the VLM by updating output token configurations of the VLM to reduce processing time of the multiple video feeds.
